(19) United States
(12) Patent Application Publication
(10) Pub. No.: US 2017/0091493 A1
(43) Pub. Date: Mar. 30, 2017

(54) Modular Card Reader

(71) Applicant: Bally Gaming, Inc., Las Vegas, NV (US)

(72) Inventors: Rolland Steil, Las Vegas, NV (US); Brian Riffel, Reno, NV (US); Daisy Palal, Las Vegas, NV (US)

(21) Appl. No.: 14/864,295

(22) Filed: Sep. 24, 2015

(51) Int. Cl. G06K 7/08

(52) U.S. Cl. CPC G06K 7/087

(57) ABSTRACT

A modular identification card reader is provided which includes a bezel sub-assembly to be secured to an enclosure such as a gaming device cabinet and a card reader and controller sub-assembly. A releasable connection is provided between the bezel sub-assembly and reader and controller sub-assembly such that, in situ, a defective reader and controller sub-assembly may be disconnected from the bezel sub-assembly and replaced by any card reader and controller sub-assembly which includes an adaptive connection to mate with the bezel sub-assembly. Therefore only the defective reader and controller sub-assembly need be replaced rather than an entire card reader assembly. Further the bezel sub-assembly and reader and controller sub-assembly may be outsourced to multiple vendors to reduce costs.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The field of the invention relates generally to magnetic stripe card readers and readers for identification tokens such as smart card, smart phone and other RFID/NFC enabled devices. More particularly the invention relates to card readers in a casino environment such as magnetic stripe player loyalty card readers.

2. Background

For some time casino enterprises have used player loyalty programs to provide players with incentives based upon the player's activities at the enterprise. When a loyalty program is adopted by an enterprise players are enrolled at a service center where personal information is obtained, a player account is created for the player and the player is issued a magnetic stripe card encoded with identification data to tie the card to the player's account which is maintained and services by one or more backend servers and database(s). At interface points such as gaming machines, gaming tables, kiosks and point of sale (POS) locations magnetic stripe card readers are installed to read the magnetic stripe on the card and provide the read data over a network to one or more data utilization resources including accessing the player's account. One commercial player tracking system is a Bally CMS(r) system sold by Bally Technologies, Inc. of Las Vegas, Nev.

Player tracking can be either at a single venue or on a nationwide basis across several casino enterprises such as described in Boushy, U.S. Pat. No. 7,419,427 issued Sep. 2, 2008 and titled “National Customer Recognition System and Method”, the disclosure of which is incorporated by reference.

At an electronic gaming machine (EGM), a card reader is installed and is in communication though a network with the backend server(s) and databases(s). When a player engages in gaming activities, the player inserts their player card into the card reader whereupon the player's gaming activities can be tracked for the purpose of providing incentives to the player such a loyalty points accumulated based upon the play level of the player. These loyalty points can be redeemed for gaming credits, cash, meals, entertainment or the like. The same is true where such card readers are provided at gaming tables or POS locations.

FIGS. 1 and 5 illustrate a typical installation of a card reader at an EGM referred to herein as a gaming device 10 according to the prior art. At a gaming device 10 a player tracking module 28 is provided by the system provider is installed which includes various components including a card reader 32. The card reader 32 is provided as a monolithic unit including an exterior bezel 500 riveted to a substrate 502 which mounts the card reader 504 and controller 506. In FIG. 5 the bezel 500 and substrate 502 are shown broken apart for clarity. The controller 506 is a logic board including firmware/software to process signals from the card reader 504 and may control local features, such as lighting an LED array 508 including its own PCB (printed circuit board) behind an LED lens array 510. The bezel 500 defines a throat 512 surrounded by a lip 514 to guide and receive insertion of a magnetic stripe card to be read by the card reader 504. The LED array 508 provides a visual indication regarding the reading of the card by various lighting patterns or colors. Paulsen, US Pub. App. 2005/0153768 titled “Gaming Machine Bonusing Method Utilizing a Player Tracking Card”; filed Jan. 8, 2004 discloses a lighted bezel at the card reader. The card reader 32 includes power and communication harnesses, such as harness 516, to connect the controller 506 to the LED array 508 and to one or more processors within the gaming device 10 such as the EGM processor board and GMU which communicates with data utilization resources such as the back end system.

While FIG. 5 shows the card reader 32 in an exploded view for clarity it should be understood that it is assembled and sold as a unit.

The monolithic card reader 32 is secured to the player tracking module 32 which also includes a PTM display 30, keypad and a ticket/bill printer 36.

As can be appreciated a casino enterprise with perhaps several thousand gaming machines and numerous gaming tables will have a like number of player card readers. Other enterprises include magnetic stripe card readers such as kiosks at airline terminals, bank ATMs and the like. These readers may be configured to read loyalty cards or credit/debit cards. These card readers from time-to-time fail and require replacement. The card readers are removed as a unit from the PTM 32, discarded and the reader is replaced. Card reader manufactures may retire certain reader assemblies making replacement of prior, failed versions difficult. Still further, using a standard, monolithic card reader design makes using multiple manufacturing sources difficult as well. Thus a system provider may have a sole source for readers frustrating the ability to search for better pricing.

It would be advantageous if a modular card reader could be provided which would enable lower cost replacement of failed readers and which would enable multiple sourcing for card readers.

It has also been known to provide wireless interfaces for reading wireless enabled devise such as smart cards, smart phones and the like. It would be beneficial to be able to combine wireless functionality with magnetic stripe card readers for reading, for example, legacy magnetic stripe cards as well as the more modern wireless devices. It has also been known to provide cameras at gaming machines for acquiring images of player such as for biometric identification. It would be beneficial to be able to include a camera with a modular card reader as well.

### SUMMARY OF THE INVENTION

There is, therefore, provided in accordance with the present invention a modular card reader which enables replacement of card reader components in the field, which enables components to be sourced from various vendors to hold down costs, which supports upgrades to card readers and which, in another aspect, can support wireless communication with devices such as wireless, portable identification units as well as one or more cameras.

Toward this end and according to one aspect of the present invention, a modular card reader is set forth for adapting a plurality of card readers having different form factors is provided to receive a user identification card for reading thereof and a coupling for connection to a power source and for passing data between the card reader and one or more data utilization resources such as a back-end player tracking system. The modular card reader is adapted for a device of the type having an enclosure with an interior and an exterior and including an opening for mounting the modular card reader assembly. The modular card reader assembly includes a coupling plate sub-assembly secured at the enclosure opening and has a slot for receiving a user's identification card to the card reader for reading thereof. A controller sub-assembly removeably attaches to the coupling plate assembly. Hence, when a reader fails only the controller sub-assembly needs to be replaced. The coupling plate sub-assembly and controller sub-assembly are provided with a mechanical coupling whereby any controller sub-assembly compatible with the coupling can be used facilitating multiple supply sources for controller sub-assemblies.

In an embodiment the improved card reader assembly includes an exterior bezel which houses a wireless receiver and/or a camera and interfaces with a keypad for supporting wireless communication via the card reader assembly as well as player biometric recognition. Power and data connections are provided between the receiver and/or camera and the controller sub-assembly.

Other features and numerous advantages of the various embodiments will become apparent from the following detailed description when viewed in conjunction with the corresponding drawings.

### BRIEF DESCRIPTION OF THE DRAWINGS

FIG. 1 illustrates a gaming terminal;

FIGS. 2A-B illustrate an example of a gaming terminal operational platform and components for a gaming terminal of the type of the present invention;

FIG. 3 is a block diagram of the logical components of a gaming kernel for a gaming terminal.

FIGS. 4A and 4B is a schematic of an example of a casino enterprise network incorporating gaming terminals;

FIG. 5 is an exploded view of a card reader assembly according to the prior art;

FIG. 6 is a perspective view of a modular card reader assembly according to an embodiment of the present invention;

FIG. 7 is a bottom-front view of the mounting plate sub-assembly for the modular card reader assembly of FIG. 6;

FIG. 8 is a rear view of the mounting plate sub-assembly for the modular card reader assembly of FIG. 6;

FIG. 9 is a front view of the controller sub-assembly for the modular card reader assembly of FIG. 6;

FIG. 10 rear-bottom view of the controller sub-assembly for the modular card reader assembly of FIG. 6;

FIG. 11 is a front-side-bottom perspective view of the controller sub-assembly for the modular card reader assembly of FIG. 6;

FIG. 12 is a top-side assembly view for the modular card reader assembly mounting to a player tracking module bracket; and

FIG. 13 is an assembly view of an additional embodiment of the modular card reader including a wireless interface and camera.

### DETAILED DESCRIPTION

While the present invention is primarily described with reference to card readers associated with gaming machines and tables located within casino enterprises, it should be understood that the present invention and its various embodiments could be extended to other enterprises using similar card readers such as stores, ATMs or other businesses which use either insertion type card readers (as opposed to swipe-type card readers) or use RFID or other wireless identification devices for players or users.

Gaming Enterprise Environment

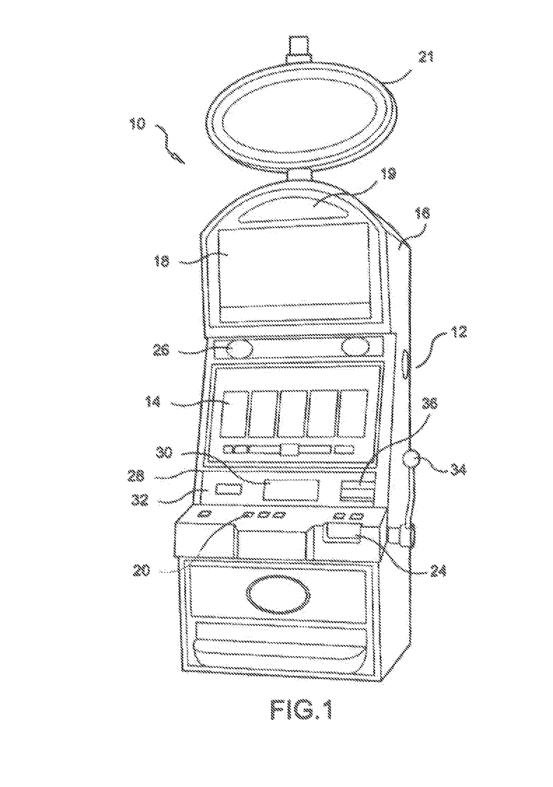

Referring now to the drawings, wherein like reference numbers denote like or corresponding elements throughout the drawings, and more particularly referring to FIG. 1, a gaming device 10 according to one or more embodiments of the present invention is shown. The gaming device 10 includes a cabinet 12 providing an enclosure for the several components of the gaming device 10 and associated equipment. A primary game display 14 is mounted to the cabinet 12. The primary game display 14 may be a video display such as an LCD, plasma, OLED or other electronic display or it may be an electro-mechanical display such as electro-mechanical stepper reels as are known in the art. The primary game display 14 may also be embodied as a combination of two or more electronic or mechanical displays disposed in an adjacent overlapping or overlying arrangement. The primary game display 14 may be mounted to one or more of a door for the cabinet 12 or the cabinet chassis itself. The primary game display 14 is located to display game content (and if desired other content) to the player. For example, the game content may be game outcomes presented by a plurality of video or electro-mechanical reels displaying symbols the combinations of which define winning or losing outcomes, video Poker, Keno or other form of base casino wagering game as is known in the art. Where the primary game display 14 is a video display, features such as bonus/feature games may also be presented. The foregoing description should not be deemed as limiting the content (graphics, video or text) which can be displayed at the primary game display 14. The cabinet 12 may comprise a slant-top, bar-top, or table-top style cabinet as is known in the art.

The gaming device 10 also includes in one or more embodiments a top box 16 which may support a printed back-lit glass (not shown) as is known in the art depicting the rules, award schedule, attract graphics or it may support a secondary game display 18 which may be of one of the types described above with reference to the primary game display 14. The top box 16 may also support a backlit glass with graphics defining a marquee 19 and a topper 21 including additional graphics.

To enable a player to provide input to the controller for the gaming device 10 a plurality of buttons 20 may be provided on a button deck for the gaming device 10. Additionally and alternatively one or both of the primary and secondary game displays 14, 18 may include touch screen input devices as are known in the art. Buttons, selections or inputs are displayed at the primary and secondary game displays 14, 18 and the player touching those icons or designated areas provides the required or desired input to configure and play the gaming device 10.

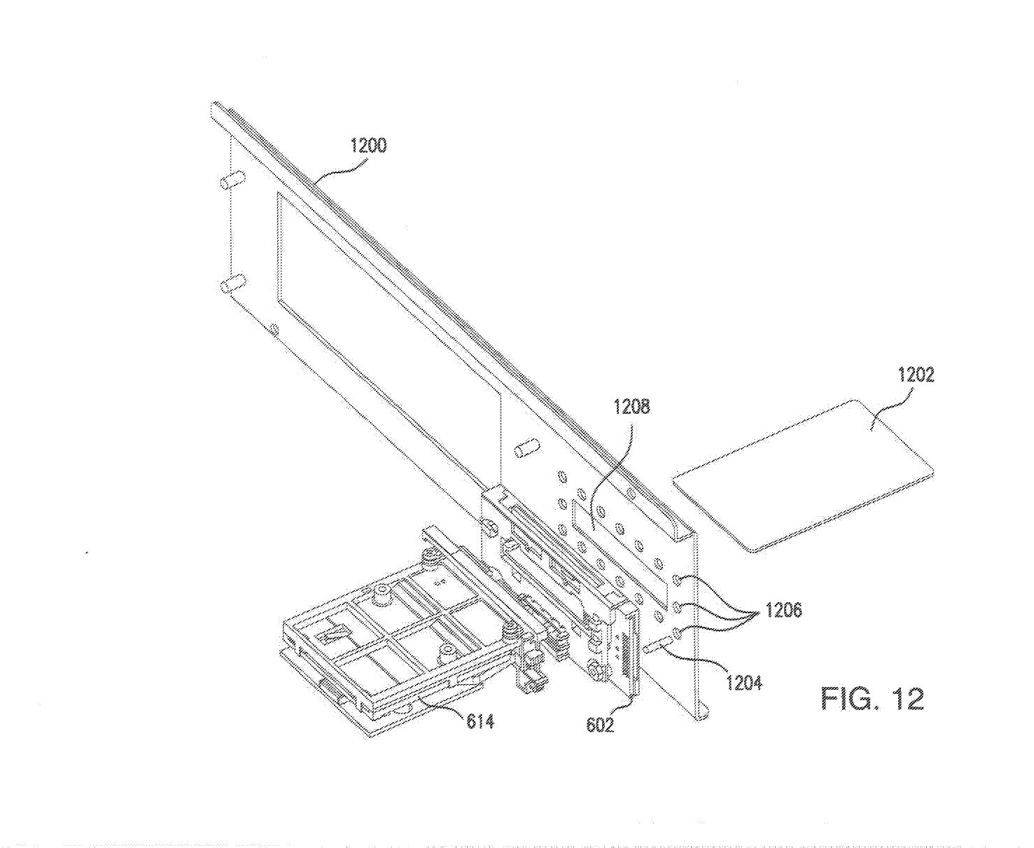

Other peripherals or associated equipment for the gaming device 10 include a bill/voucher acceptor 24 which reads and validates currency and vouchers for the player to establish credits for gaming on the gaming device 10 and one or more speakers 26 to provide audio content to the player in association with the game play. To provide for communication between the gaming device 10 and a casino system, a player tracking module (PTM) 28 is mounted on the cabinet 12. When a casino enterprise adopts a player tracking loyalty system, PTMs 28 are installed on the gaming devices 10 (typically by the device provider) to provide a system interface to tracking the player's gaming activities (e.g. wagers, wins, time of play, duration of play) as well as provide for messaging to the player from the system and interfacing with the gaming device 10 such as to enable promotional play. PTM 28 has a PTM display 30 to display system related information to the player. The PTM display 30 may be a small LCD, plasma or OLED display with touch screen functionality. A card reader 32 is provided to read a machine readable component on a player loyalty card (not shown) issued to the player to identify the player to the casino system as in known in the art as described in the Background above. A ticket printer 36 may be provided as well on the PTM 28 or elsewhere on the gaming device 10 to provide printed value ticket vouchers to players when they cash out as is also known in the art. The peripherals for the PTM are mounted to a PTM bracket 1200 (shown in a rear view in FIG. 12) which is secured to the gaming machine cabinet 12.

While the player may use the buttons 20 to prompt play of the game (or the touch screen input), alternatively the player may use a handle 34 to prompt an input as is known in the art.

Cabinet 12 may be a self-standing unit that is generally rectangular in shape and may be manufactured with reinforced steel or other rigid materials which are resistant to tampering and vandalism. Any shaped cabinet may be implemented with any embodiment of gaming device 10 so long as it provides access to a player for playing a game. For example, cabinet 12 may comprise a slant-top, bar-top, or table-top style cabinet, including a Bally Cinevision(tm) or CineReels(tm) cabinet. The gaming device 10 may include a controller and memory disposed within the cabinet 12 or may have thin client capability such as that some of the computing capability is maintained at a remote server.

The plurality of player-activated buttons 20 may be used for various functions such as, but not limited to, selecting a wager denomination, selecting a game to be played, selecting a wager amount per game, initiating a game, or cashing out money from gaming device 10. Buttons 20 may be operable as input mechanisms and may include mechanical buttons, electromechanical buttons or touch screen buttons. In one or more embodiments, buttons 20 may be replaced with various other input mechanisms known in the art such as, but not limited to, touch screens, touch pad, track ball, mouse, switches, toggle switches, or other input means used to accept player input. For example, one input means is as disclosed in U.S. Pub. App. 2011/0111853, entitled “Universal Button Module,” filed on Jan. 14, 2011 and/or U.S. Pub. App. 2010/0113140 entitled “Gesture Enhanced Input Device” filed Nov. 16, 2009 which are hereby incorporated by reference. Player input may also be by providing touch screen functionality at the primary game display 14 and/or secondary game display 18.

The primary game display 14 may present a primary game of chance wherein, for a wager, a player receives one or more outcomes from a set of potential outcomes. For example, one such game of chance is a video slot machine game. In other aspects of the invention, gaming device 10 may present a video or mechanical reel slot machine, a video keno game, a lottery game, a bingo game, a Class II bingo game, a roulette game, a craps game, a blackjack game, a mechanical or video representation of a wheel game or the like. In a casino environment the base game is most often a pay-to-play (P2P) game meaning that the player must stake a wager to receive either a winning or losing outcome.

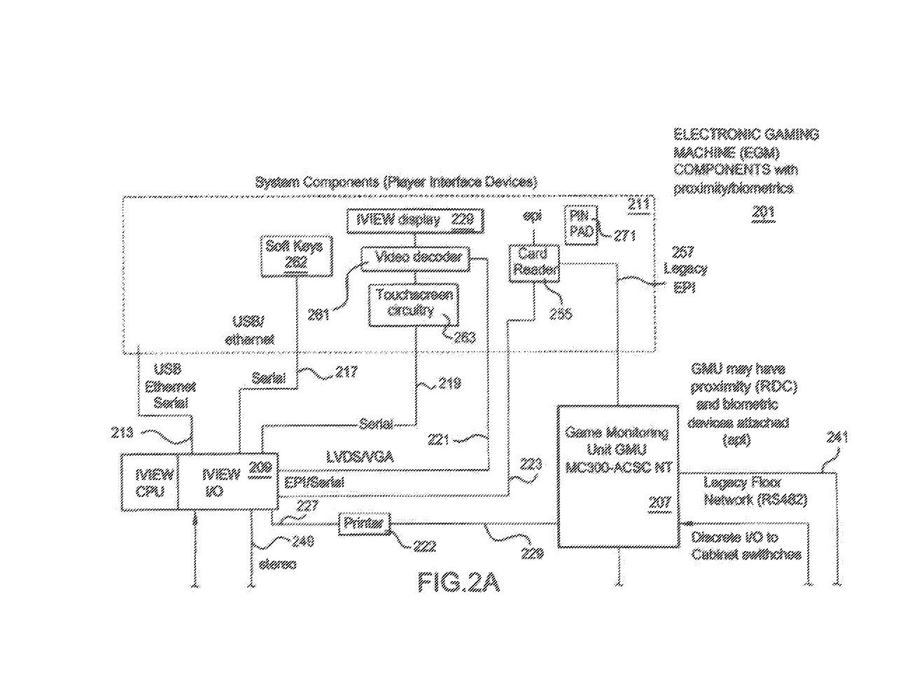

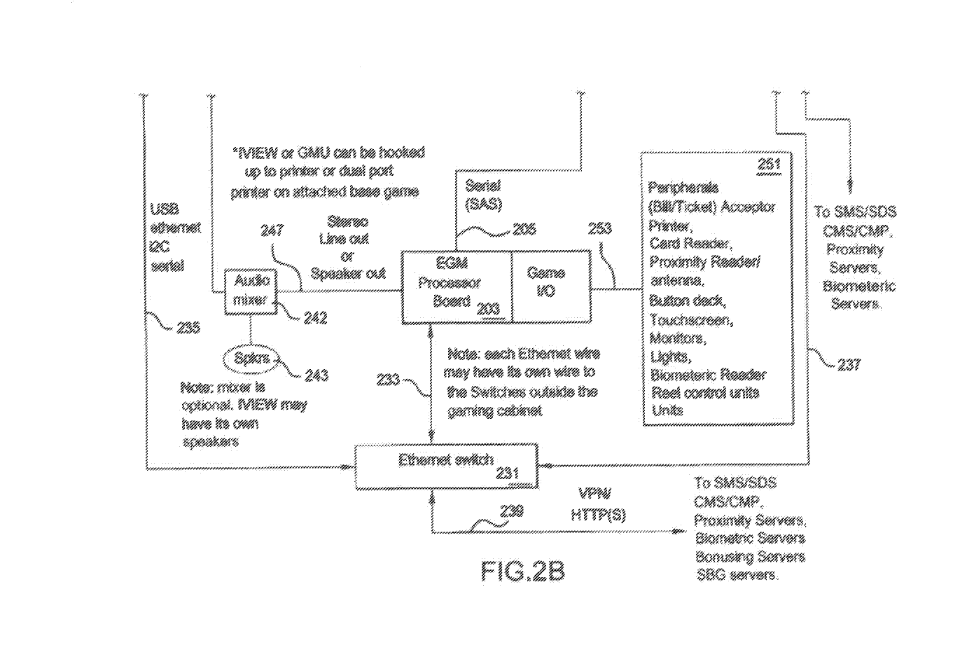

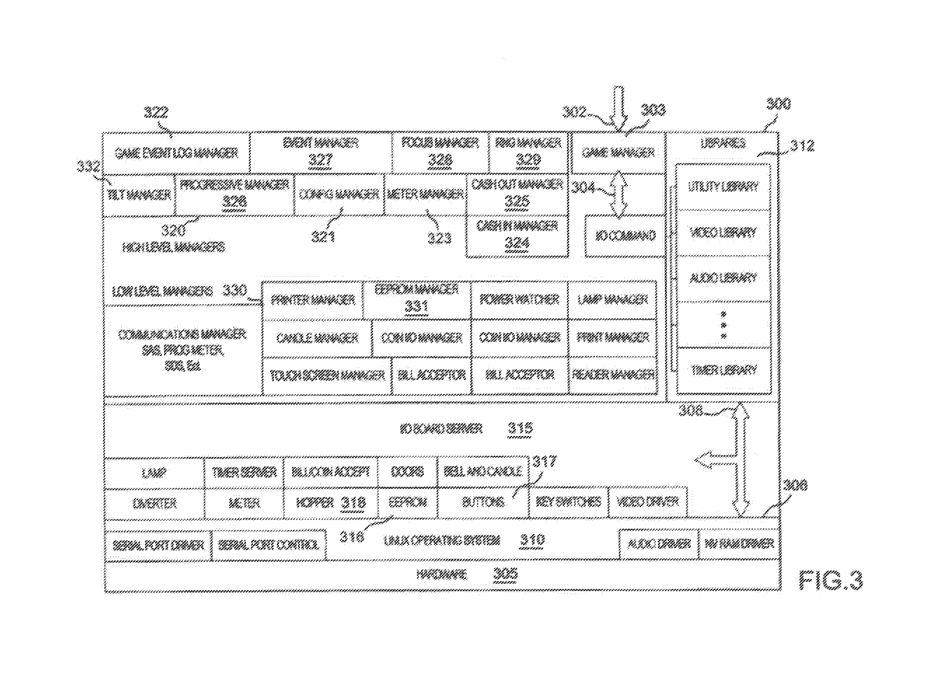

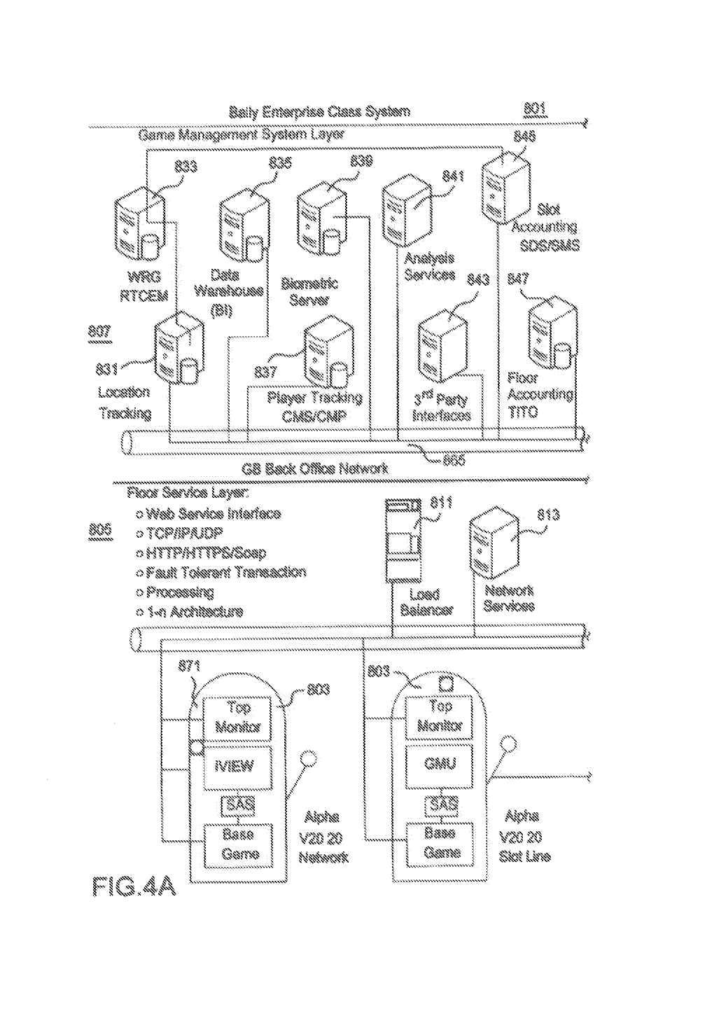

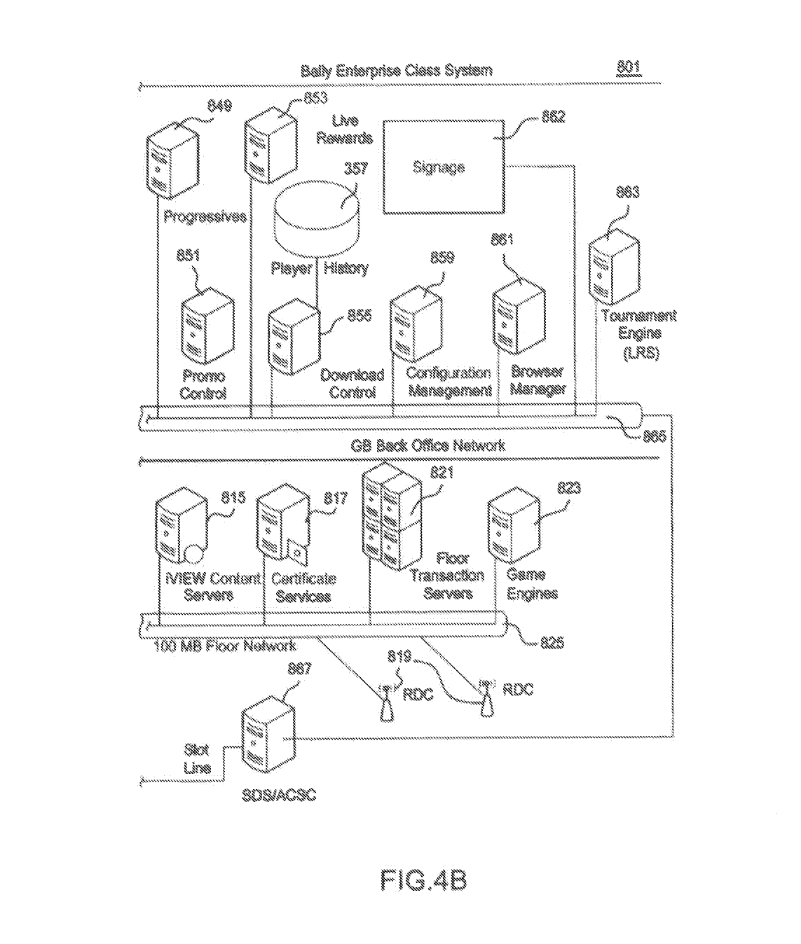

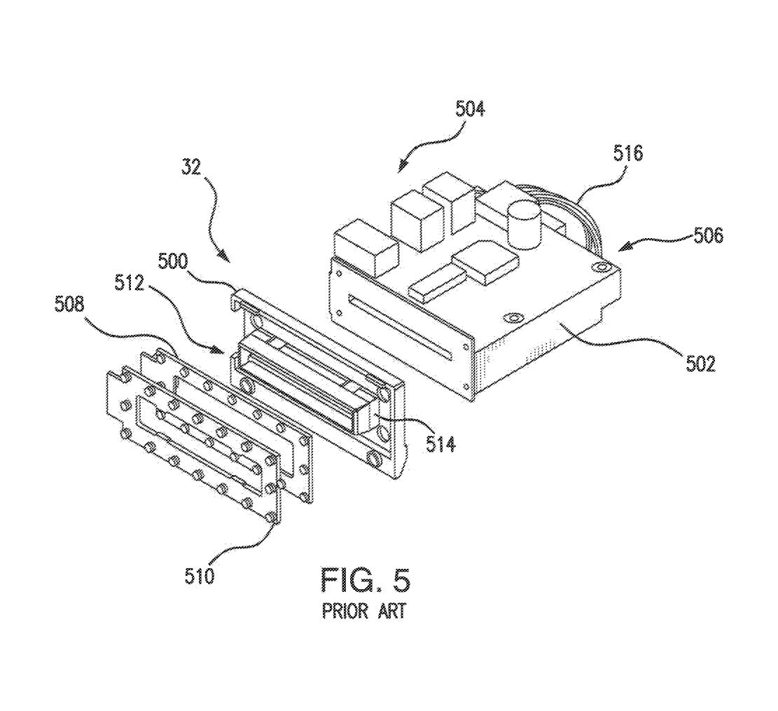

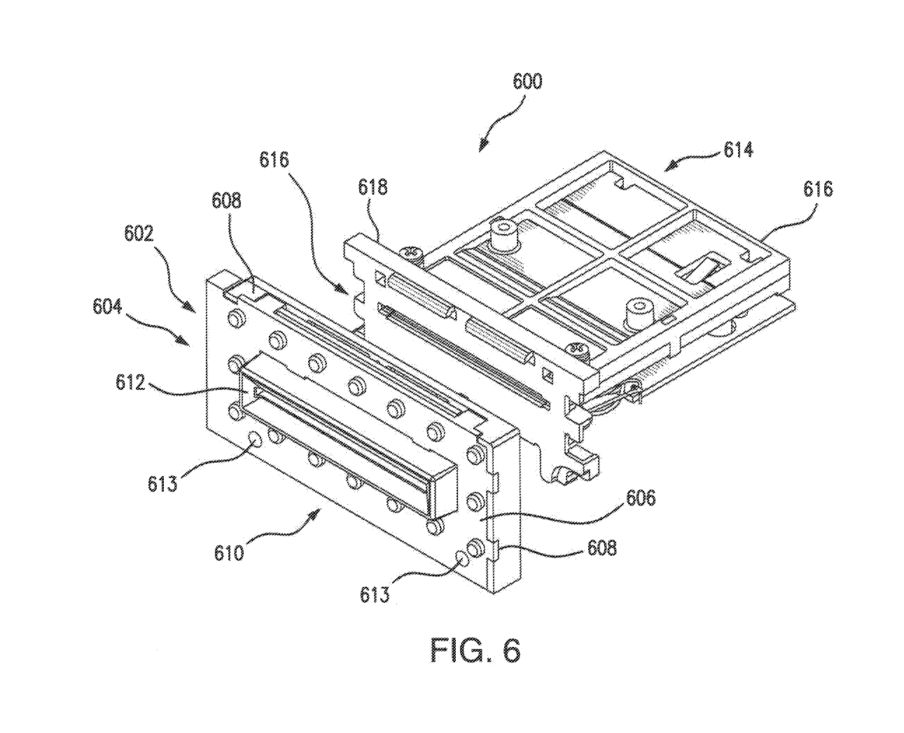

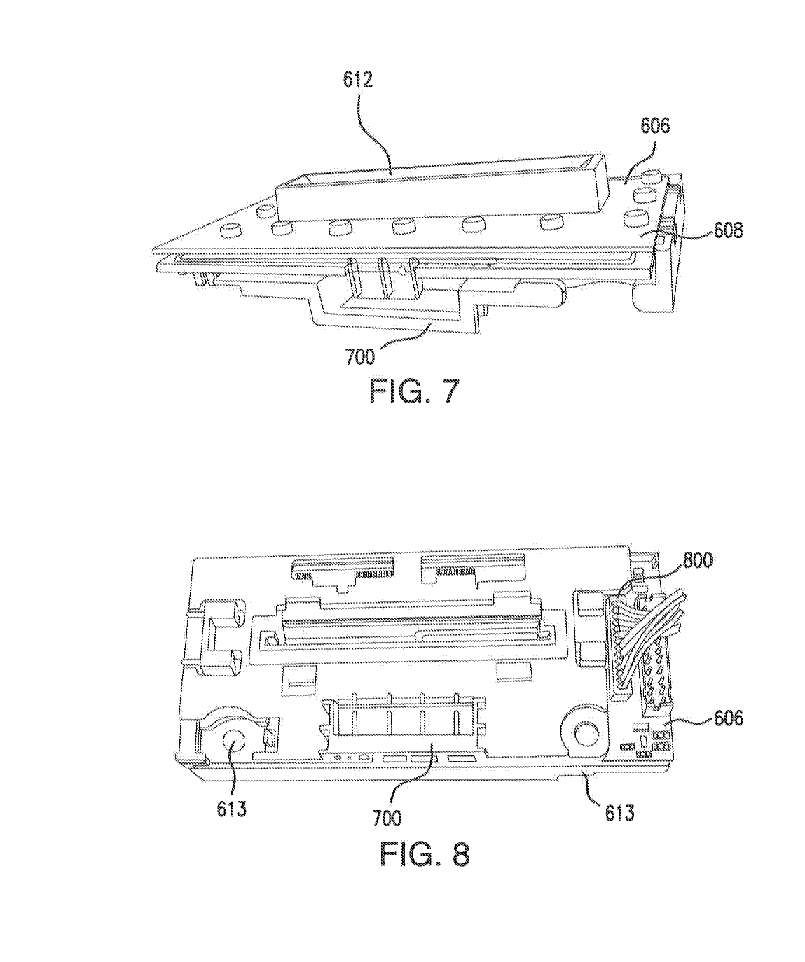

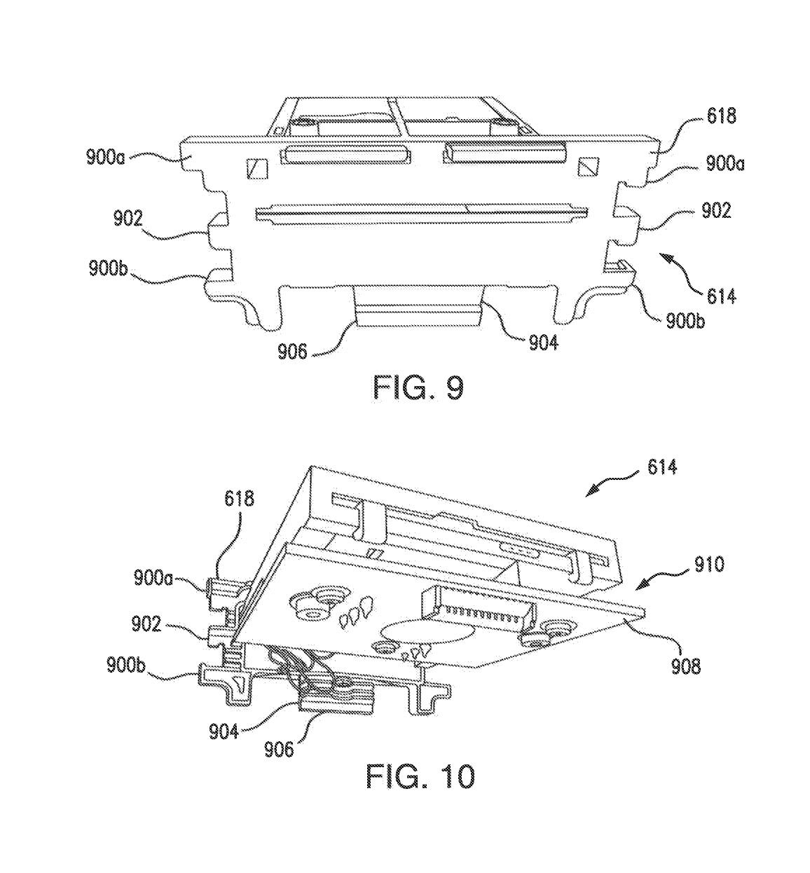

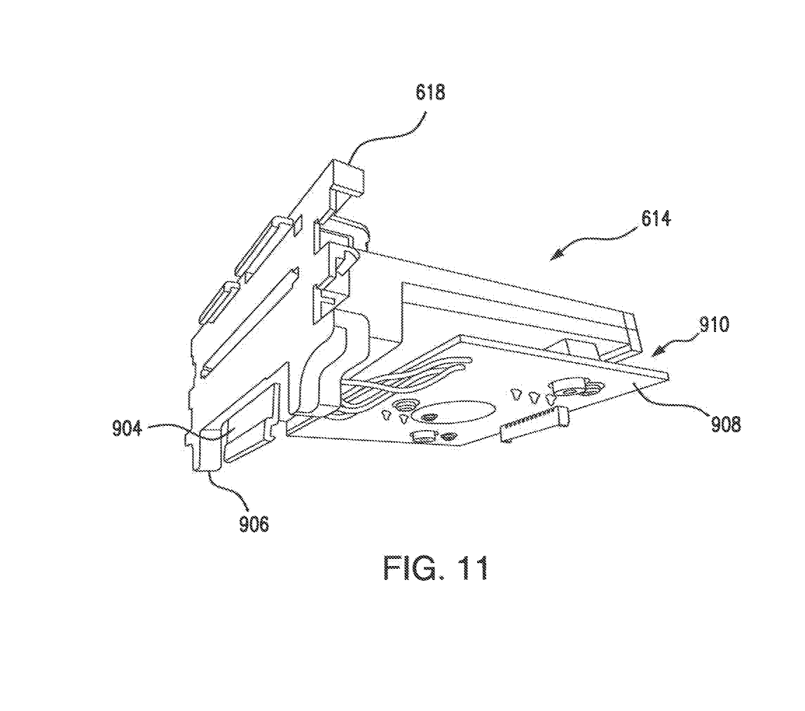

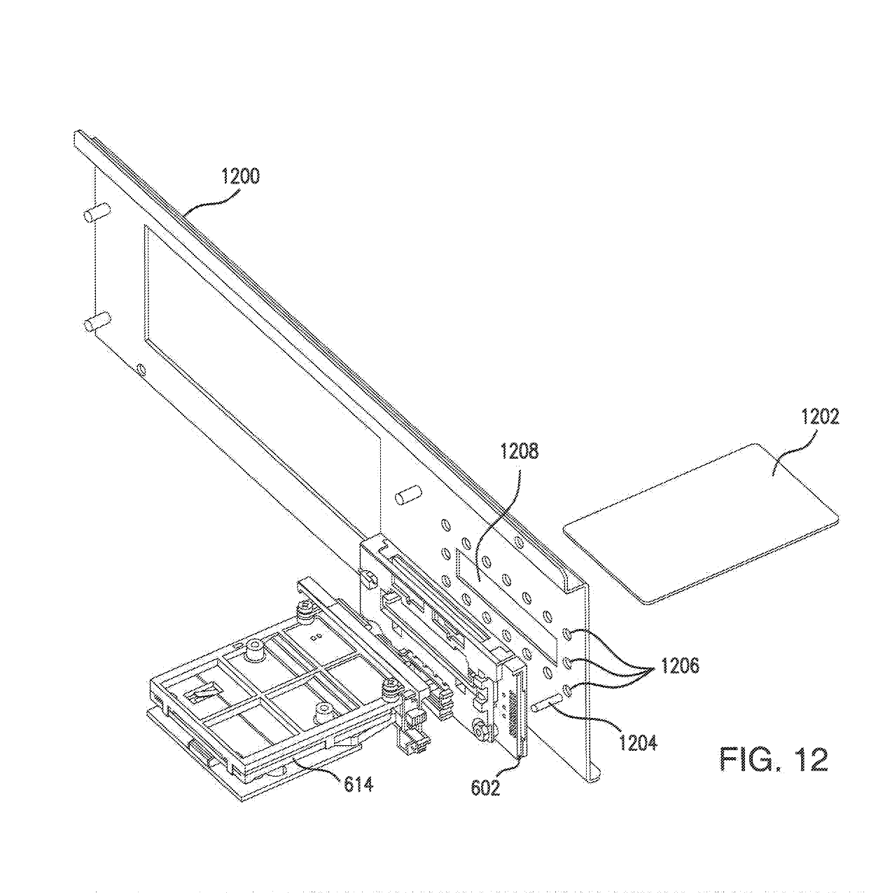

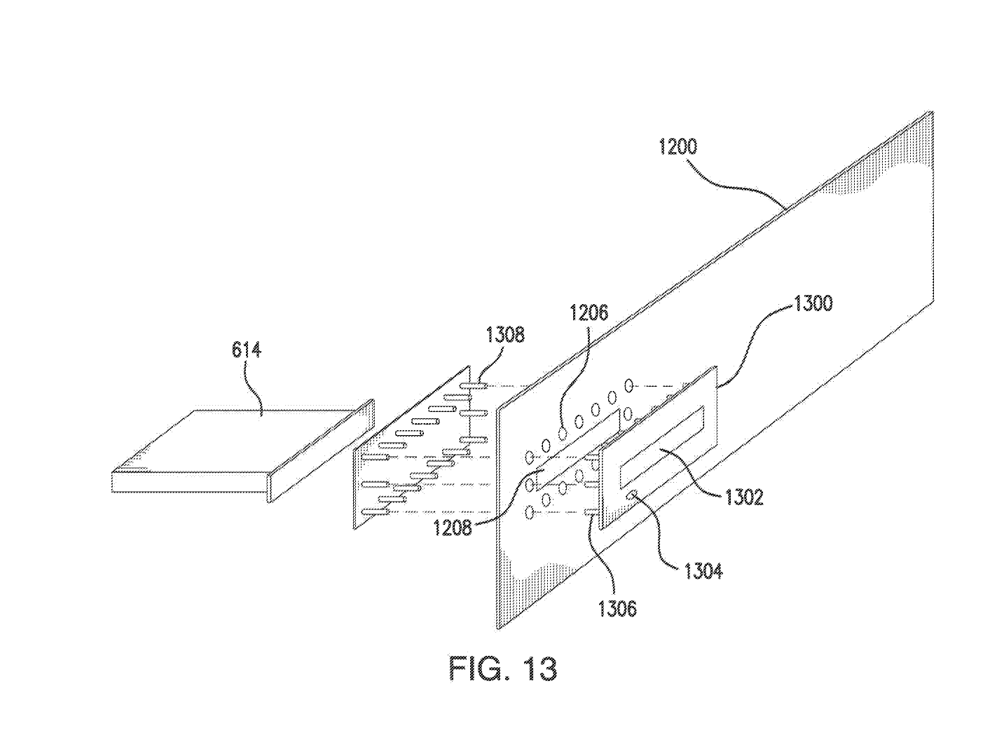

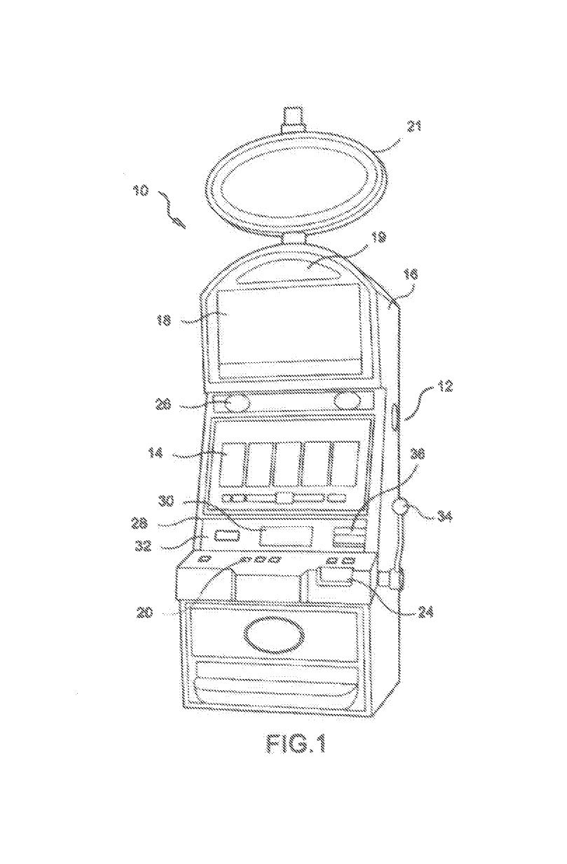

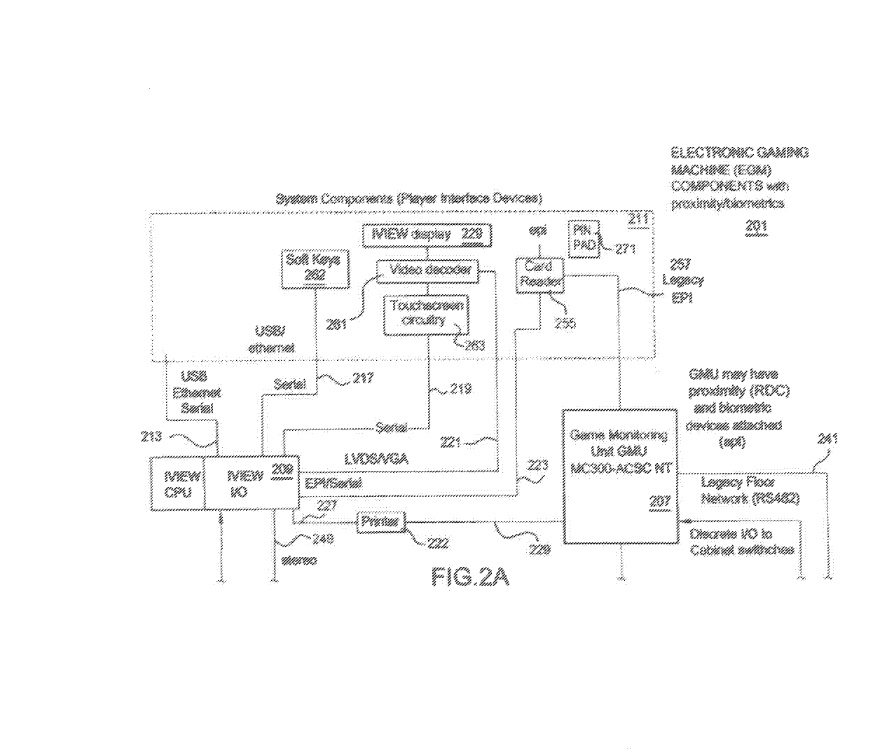

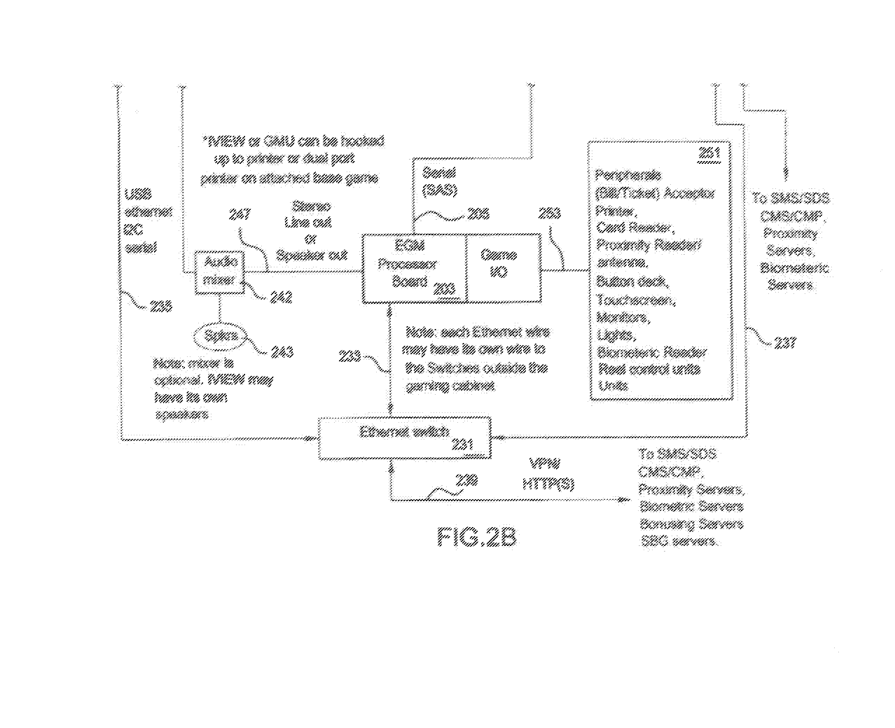

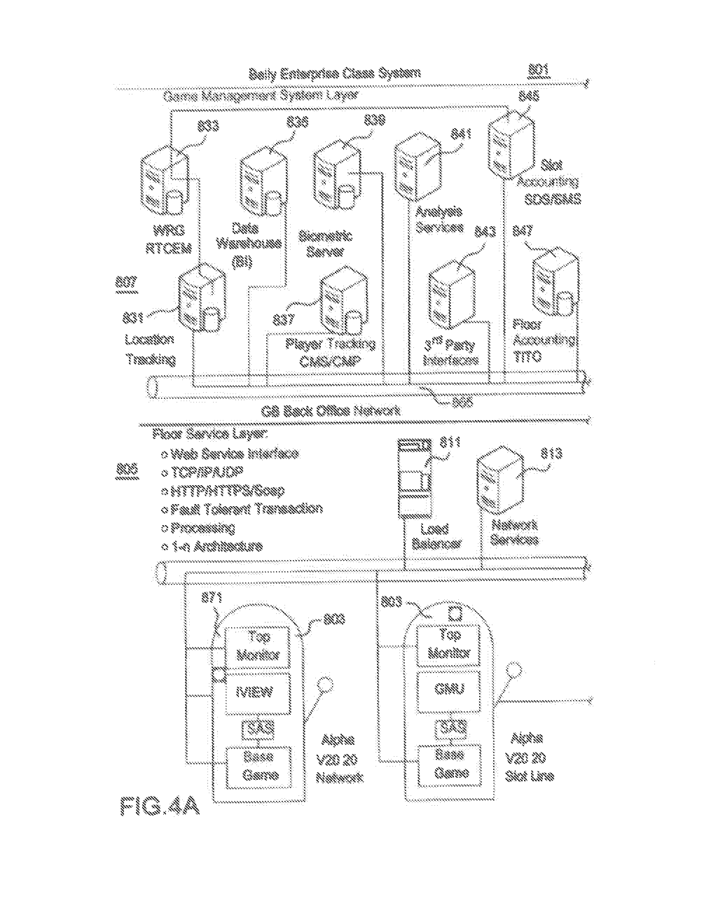

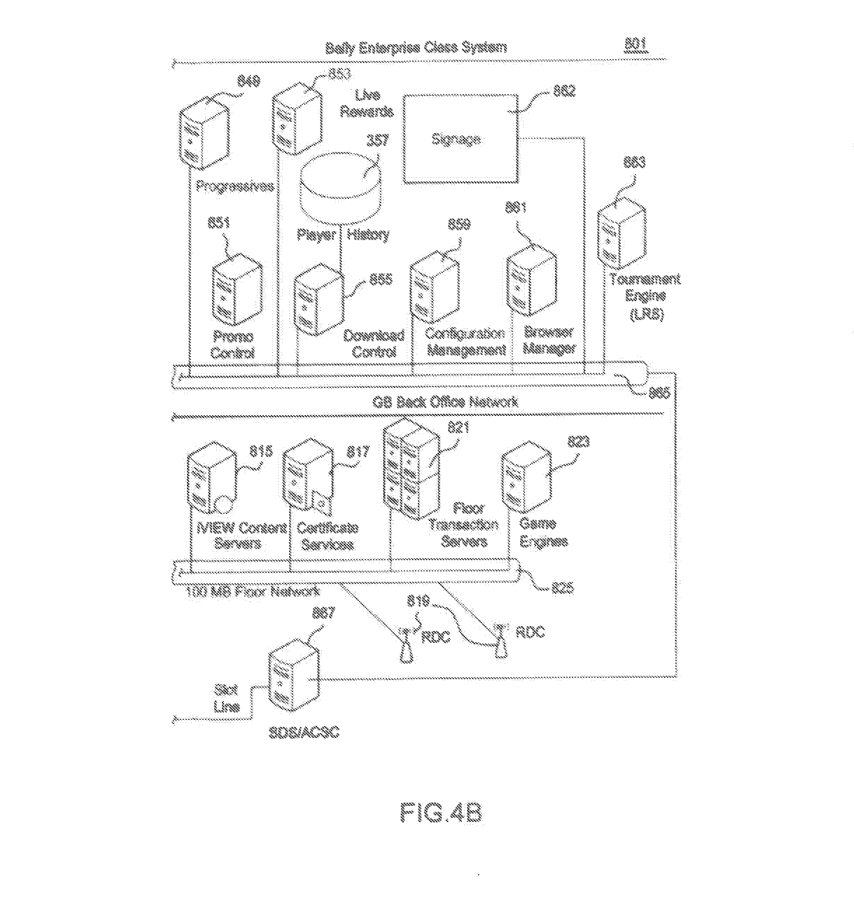

Referring to FIGS. 2A, B, the gaming device 10 hardware 201 for the controller(s) is shown in accordance with one or more embodiments. The hardware 201 includes EGM processor board 203 connected through serial bus line 205 to game monitoring unit (GMU) 207 (such as a Bally MC300 or ACSC NT manufactured and sold by Bally Gaming, Inc., Las Vegas, Nevada). EGM Processor Board 203 is connected to the player interface I/O device (PID) 209 over bus line 249. The PID 209 is connected to the PTM 28 such as the iView device 211 (“iView” is a trade name used by Bally Gaming, Inc. for its player tracking module 28) in FIG. 2A through bus lines 213, 217, 219, 221, 223. The PID 209 provides for communication between the casino system such as the type as hereinafter described. Inasmuch as gaming devices 10 may be manufactured by different entities, mounting like PTMs 28, 211 and PIDs 209 at each gaming device 10 provides for communication to the system in one or more common message protocols. Gaming voucher ticket printer 36 (for printing player cash out tickets) (shown as 222 in FIG. 2A) is connected to PID 209 and GMU 207 over bus lines 227, 229. EGM Processor Board 203, PID 209 and GMU 207 connect to Ethernet switch 231 over bus lines 233, 235, 237. Ethernet switch 231 connects to a slot management system and a casino management system (SMS, SDS, CMS and CMP) (FIGS. 4A, 4B) network over bus line 239. Ethernet switch 231 may also connect to a server based gaming server or a downloadable gaming server. GMU 207 also may connect to the network over bus line 241. Speakers 26 (shown as 243 in FIG. 2B) to produce sounds related to the game or according to the present invention connect through audio mixer 242 and bus lines 247, 249 to EGM Processor Board 203 and PID 209.

Peripherals 251 connect through bus 253 to EGM Processor Board 203. The peripherals 251 include, but are not limited to the following and may include individual processing capability: bill/voucher acceptor 24 to validate and accept currency and ticket vouchers, card reader 32/255 the player interfaces such a buttons 20, primary and secondary game displays 14, 18 and any secondary or tertiary displays (with/without) touch screen functionality, monitors and lights. The peripherals 251 may include the displays as hereinafter described with reference to the various embodiments of the present invention as herein described or their equivalents. For example, the bill/voucher acceptor 24 is typically connected to the game input-output board of the EGM processing board 203 (which is, in turn, connected to a conventional central processing unit (“CPU”) board), such as an Intel Pentium(r) microprocessor mounted on a gaming motherboard. The I/O board may be connected to EGM processor board 203 by a serial connection such as RS-232 or USB or may be attached to the processor by a bus such as, but not limited to, an ISA bus. The gaming motherboard may be mounted with other conventional components, such as are found on conventional personal computer motherboards, and loaded with a game program which may include a gaming machine operating system (OS), such as a Bally Alpha OS. EGM processor board 203 executes a game program that causes the gaming device 10 to display and play a game. The various components and included devices may be installed with conventionally and/or commercially available components, devices, and circuitry into a conventional and/or commercially available gaming terminal cabinet 12.

When a player has inserted a form of currency such as, for example and without limitation, paper currency, coins or tokens, cashless tickets or vouchers, electronic funds transfers or the like into the currency acceptor, a signal is sent by way of bus 253 to the I/O board and to EGM processor board 203 which, in turn, assigns an appropriate number of credits for play in accordance with the game program. The player may further control the operation of the gaming machine by way of other peripherals 251, for example, to select the amount to wager via the buttons 20. The game starts in response to the player operating a start mechanism such as the handle 34, button 20 such as a SPIN/RESET button or a touch screen icon. The game program includes a random number generator to provide a display of randomly selected indicia on one or more displays such as the primary game display 14 as shown in FIG. 1. In some embodiments, the random generator may be physically separate from gaming device 10; for example, it may be part of a central determination host system which provides random game outcomes to the game program. Finally, EGM processor board 203 under control of the game program and OS compares the outcome to an award schedule. The set of possible game outcomes may include a subset of outcomes related to the triggering and play of a feature or bonus game. In the event the displayed outcome is a member of this subset, EGM processor board 203, under control of the game program and by way of I/O Board, may cause feature/bonus game play to be presented on the primary game display 14 and/or any secondary display(s) 18. Wager and outcome information, e.g. awards/loses and time of play, may be provided to the backend systems via the PTM 28/211. A player's loyalty card read by the card reader 32/255 enables the system to allocate the information to a player's account.

Predetermined payout amounts for certain outcomes, including feature game outcomes, are stored as part of the game program. Such payout amounts are, in response to instructions from EGM processor board 203, provided to the player in the form of coins, credits or currency via I/O board and a pay mechanism, which may be one or more of a credit meter, a coin hopper, a voucher printer, an electronic funds transfer protocol or any other payout means known or developed in the art.

GMU 207 includes an integrated circuit board and GMU processor and memory including coding for network communications. As shown, GMU 207 may connect to the card reader 32 (shown as 255 in FIG. 2A) through bus 257 and may thereby obtain player information and transmit the information over the network through bus 241. Gaming activity information may be transferred by the EGM Processor Board 203 to GMU 207 where the information may be translated into a network protocol, such as S2S, for transmission to a server, such as a player tracking server, where information about a player's playing activity may be stored in a designated server database.

PID 209 includes an integrated circuit board, PID processor (iView CPU), and memory which includes an operating system software, a player interface program which may be executable by the PID 209 processor together with various input/output (I/O) drivers for respective devices which connect to PID processor and which may further include various games or game components playable on PTM 28, 211 or playable on a connected network server and PTM 28, 211 is operable as the player interface. PID 209 connects to card reader 32 (shown as 255 in FIG. 2A) through bus 223, player tracking display 30 (shown as iView display 229 in FIG. 2A) through video decoder 261 and bus 221, such as an LVDS or VGA bus.

As part of its programming, the PID 209 processor executes coding to drive player tracking display 30, 229 and provide messages and information to a player. Touch screen circuitry 263 interactively connects PTM display 30, 229 and video decoder 261 to PTM 28, 211 such that a player may input information and causes the information to be transmitted either on the player's initiative or responsive to a query. Additionally soft keys 262 connect through bus 217 to PID 209 and operate together with the player tracking display 30 to provide information or queries to a player and receive responses or queries from the player. PID 209, in turn, communicates over the CMS/SMS network through Ethernet switch 231 and busses 235, 239 and with respective servers, such as a player tracking server.

PTMs 28 are linked into the virtual private network of the system components in gaming device 10. The system components include the player tacking module 28, 211 (e.g. Bally iVIEW® device) (‘iView” is a registered trademark of Bally Gaming, Inc.), PID 209, EGM processing board 203 and game monitoring unit (GMU) 207. These system components may connect over a network to the slot management system (such as a commercially available Bally SDS/SMS) and/or casino management system (such as a commercially available Bally CMP/CMS).

The GMU 207 system component has a connection to the base game through a serial SAS connection and is connected to various servers using, for example, HTTPs over Ethernet. Through this connection, firmware, media, operating system software, gaming machine configurations can be downloaded to the system components from the servers. This data is authenticated prior to installation on the system components.

The system components include the PTM 28, 211 processing board (PID 209) and game monitoring unit (GMU) 207. The GMU 207, PID 209 and PTM 28 can be combined into one like the commercially available Bally GTM iVIEW device. This device may have a video mixing technology to mix the EGM processor's video signals with the iVIEW display onto the top box monitor or any monitor on the gaming device.

The PTM 28, 211 may also interface with a switcher and router device of the type described above. In such case, instead of providing the PTM display 30, the switcher and router device provides for the content normally display at the PTM display 30 to be displayed at one or more of the primary or secondary displays 14, 18.

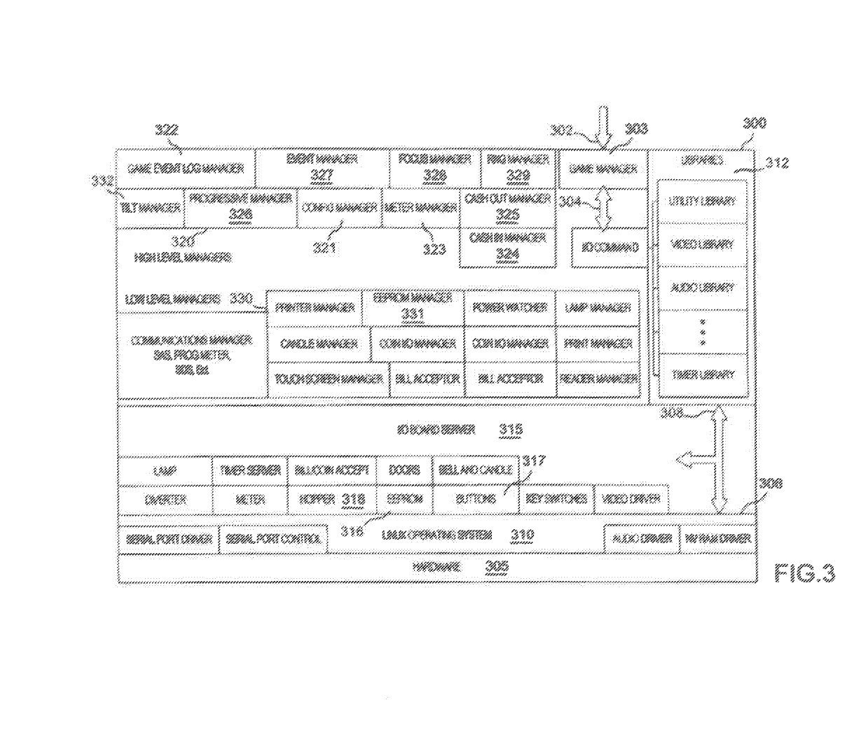

In accordance with one or more embodiments, FIG. 3 is a functional block diagram of a gaming kernel 300 of a game program under control of gaming device EGM processor board 203. The game program uses gaming kernel 300 by calling into application programming interface (API) 302, which is part of game manager 304. The components of game kernel 300 as shown in FIG. 3 are only illustrative, and should not be considered limiting. For example, the number of managers may be changed, additional managers may be added or some managers may be removed without deviating from the scope and spirit of the invention.

As shown in the example, there are three layers: a hardware layer 305; an operating system layer 306, such as, but not limited to, Linux; and a game kernel layer having game manager 304 therein. In one or more embodiments, the use of an operating system 310, such a UNIX-based or Windows-based operating system, allows game developers interfacing to the gaming kernel to use any of a number of standard development tools and environments available for the operating systems. This is in contrast to the use of proprietary, low level interfaces which may require significant time and engineering investments for each game upgrade, hardware upgrade, or feature upgrade. The game kernel 300 executes at the user level of the operating system layer 306, and itself contains a major component called the I/O board server 315. To properly set the bounds of game application software (making integrity checking easier), all game applications interact with gaming kernel 300 using a single API 302 in game manager 304. This enables game applications to make use of a well-defined, consistent interface, as well as making access points to gaming kernel 300 controlled, where overall access is controlled using separate processes.

For example, game manager 303 parses an incoming command stream and, when a command dealing with I/O comes in (arrow 302), the command is sent to an applicable library routine 312. Library routine 312 decides what it needs from a device, and sends commands to I/O board server 315 (see arrow 308). A few specific drivers remain in operating system layer 306's kernel, shown as those below operating system layer 306. These are built-in, primitive, or privileged drivers that are (i) general (ii) kept to a minimum and (iii) are easier to leave than extract. In such cases, the low-level communications is handled within operating system 310 and the contents passed to library routines 312.

Thus, in a few cases library routines may interact with drivers inside operating system layer 310, which is why arrow 308 is shown as having three directions (between library routines 312 and I/O board server 315, or between library routines 312 and certain drivers in operating system layer 310). No matter which path is taken, the logic needed to work with each device is coded into modules in the user layer of the diagram. Operating board server layer 306 is kept as simple, stripped down, and common across as many hardware platforms as possible. The library utilities and user-level drivers change as dictated by the game cabinet or game machine in which it will run. Thus, each game cabinet or game machine may have an industry standard EGM processing board 203 connected to a unique, relatively dumb, and as inexpensive as possible I/O adapter board, plus a gaming kernel 300 which will have the game-machine-unique library routines and I/O board server 315 components needed to enable game applications to interact with the gaming machine cabinet. Note that these differences are invisible to the game application software with the exception of certain functional differences (i.e., if a gaming cabinet has stereo sound, the game application will be able make use of API (arrow 302) to use the capability over that of a cabinet having traditional monaural sound).

Game manager 303 provides an interface into game kernel 300, providing consistent, predictable, and backwards compatible calling methods, syntax, and capabilities by way of game application API (arrow 302). This enables the game developer to be free of dealing directly with the hardware, including the freedom to not have to deal with low-level drivers as well as the freedom to not have to program lower level managers 330, although lower level managers 330 may be accessible through game manager 303's interface if a programmer has the need. In addition to the freedom derived from not having to deal with the hardware level drivers and the freedom of having consistent, callable, object-oriented interfaces to software managers of those components (drivers), game manager 303 provides access to a set of high level managers 320 also having the advantages of consistent callable, object-oriented interfaces, and further providing the types and kinds of base functionality required in casino-type games. Game manager 303, providing all the advantages of its consistent and richly functional game application API (arrow 302) as supported by the rest of game kernel 300, thus provides a game developer with a multitude of advantages.

Game manager 303 may have several objects within itself, including an initialization object (not shown). The initialization object performs the initialization of the entire game machine, including other objects, after game manager 303 has started its internal objects and servers in appropriate order. In order to carry out this function, the kernel's configuration manager 321 is among the first objects to be started; configuration manager 321 has data needed to initialize and correctly configure other objects or servers.

The high level managers 320 of game kernel 300 may include game event log manager 322 which provides, at the least, a logging or logger base class, enabling other logging objects to be derived from this base object. The logger object is a generic logger; that is, it is not aware of the contents of logged messages and events. The game event log manager's 322 job is to log events in non-volatile event log space. The size of the space may be fixed, although the size of the logged event is typically not. When the event space or log space fills up, one embodiment will delete the oldest logged event (each logged event will have a time/date stamp, as well as other needed information such as length), providing space to record the new event. In this embodiment, the most recent events will thus be found in the log space, regardless of their relative importance. Further provided is the capability to read the stored logs for event review.

In accordance with one embodiment, meter manager 323 manages the various meters embodied in the game kernel 300. This includes the accounting information for the game machine and game play. There are hard meters (counters) and soft meters; the soft meters may be stored in non-volatile storage such as non-volatile battery-backed RAM to prevent loss. Further, a backup copy of the soft meters may be stored in a separate non-volatile storage such as EEPROM. In one embodiment, meter manager 323 receives its initialization data for the meters, during start-up, from configuration manager 321. While running, the cash in manager 324 and cash out manager 325 call the meter manager's 323 update functions to update the meters. Meter manager 323 will, on occasion, create backup copies of the soft meters by storing the soft meters' readings in EEPROM. This is accomplished by calling and using EEPROM manager 331.

In accordance with still other embodiments, progressive manager 336 manages progressive games playable from the game machine. Event manager 327 is generic, like game event log manager 327, and is used to manage various gaming machine events. Focus manager 328 correlates which process has control of various focus items. Tilt manager 332 is an object that receives a list of errors (if any) from configuration manager 321 at initialization, and during game play from processes, managers, drivers, etc. that may generate errors. Random number generator manager 329 is provided to allow easy programming access to a random number generator (RNG), as a RNG is required in virtually all casino-style (gambling) games. Random number generator manager 329 includes the capability of using multiple seeds.

In accordance with one or more embodiments, a credit manager object (not shown) manages the current state of credits (cash value or cash equivalent) in the game machine, including any available winnings, and further provides denomination conversion services. Cash out manager 325 has the responsibility of configuring and managing monetary output devices. During initialization, cash out manager 325, using data from configuration manager 321, sets the cash out devices correctly and selects any selectable cash out denominations. During play, a game application may post a cash out event through the event manager 327 (the same way all events are handled), and using a call back posted by cash out manager 325, cash out manager 325 is informed of the event. Cash out manager 325 updates the credit object, updates its state in non-volatile memory, and sends an appropriate control message to the device manager that corresponds to the dispensing device. As the device dispenses dispensable media, there will typically be event messages being sent back and forth between the device and cash out manager 325 until the dispensing finishes, after which cash out manager 325, having updated the credit manager and any other game state (such as some associated with meter manager 323) that needs to be updated for this set of actions, sends a cash out completion event to event manager 327 and to the game application thereby. Cash in manager 324 functions similarly to cash out manager 325, only controlling, interfacing with, and taking care of actions associated with cashing in events, cash in devices, and associated meters and crediting.

In a further example, in accordance with one or more embodiments, I/O board server 315 may write data to the gaming machine EEPROM memory, which is located in the gaming machine cabinet and holds meter storage that must be kept even in the event of power failure. Game manager 303 calls the I/O library functions to write data to the EEPROM. The I/O board server 315 receives the request and starts a low priority EEPROM manager 331 thread within I/O board server 315 to write the data. This thread uses a sequence of 8 bit command and data writes to the EEPROM device to write the appropriate data in the proper location within the device. Any errors detected will be sent as IPC messages to game manager 304. All of this processing is asynchronous.

In accordance with one embodiment, button module 317 within I/O board server 315, polls (or is sent) the state of buttons every 2 ms. These inputs are debounced by keeping a history of input samples. Certain sequences of samples are required to detect a button was pressed, in which case the I/O board server 315 sends an inter-process communication event to game manager 303 that a button was pressed or released. In some embodiments, the gaming machine may have intelligent distributed I/O which debounces the buttons, in which case button module 317 may be able to communicate with the remote intelligent button processor to get the button events and simply relay them to game manager 303 via IPC messages. In still another embodiment, the I/O library may be used for pay out requests from the game application. For example, hopper module 318 must start the hopper motor, constantly monitor the coin sensing lines of the hopper, debounce them, and send an IPC message to the game manager 303 when each coin is paid.

Further details, including disclosure of lower level fault handling and/or processing, are included in U.S. Pat. No. 7,351,151 issued Apr. 1, 2008 entitled “Gaming Board Set and Gaming Kernel for Game Cabinets” the disclosure of which is incorporated herein by explicit reference.

Referring to FIGS. 4A and B, an example of a gaming enterprise system 801 data utilization resources is shown in accordance with one or more embodiments. Gaming enterprise system 801 may include one casino or multiple locations (herein referred to collectively as a casino enterprise) and generally includes a network of gaming terminals 803 (including gaming devices 10 of the type as described in FIG. 1), floor management system (SMS) 805, and casino management system (CMS) 807. SMS 805 may include load balancer 811, network services server 813, player tracking module 28, iView (PTM 28), content servers 815, certificate services server 817, floor radio dispatch receiver/transmitters (RDC) 819, floor transaction servers 821 and game engines 823 (where the gaming terminals 803 operate server based, server supported or downloadable games), each of which may connect over network bus 825 to gaming terminals 803. CMS 807 may include location tracking server 831, WRG RTCEM (William Ryan Group Real Time Customer Experience Management from William Ryan Group, Inc. of Sea Girt, N.J.) server 833 , data warehouse server 835, player tracking server 837 which, with one or more suitable database(s), provides for tracking of players' play at various gaming devices, awarding player loyalty points and point redemption, biometric server 839 which may support the acquisition and utilization of acquired player biometric data such as images acquired by a camera, analysis services server 841 to support business intelligence functionality, third party interface server 843, slot accounting server 845 to record and archive data related to gaming machine performance, floor accounting server 847, progressives server 849, promo control server 851, bonus game (such as Bally Live Rewards) server 853, download control server 855 to support downloading software to gaming machines and other devices such as signage and peripherals, player history database 857, configuration management server 859, browser manager 861, tournament engine server 863 connecting through bus 865 to server host 867 and gaming terminals 803. The various servers and gaming terminals 803 may connect to the network with various conventional network connections (such as, for example, USB, serial, parallel, RS485, Ethernet). Additional servers which may be incorporated with CMS 807 include a responsible gaming limit server (not shown), advertisement server (not shown), and a control station server (not shown) where an operator or authorized personnel may select options and input new programming to adjust each of the respective servers and gaming terminals 803. SMS 805 may also have additional servers including a control station (not shown) through which authorized personnel may select options, modify programming, and obtain reports of the connected servers and devices, and obtain reports. The various CMS and SMS servers are descriptively entitled to reflect the functional executable programming stored thereon and the nature of databases maintained and utilized in performing their respective functions.

The gaming terminals 803, including gaming machine 10, include various peripheral components that may be connected with USB, serial, parallel, RS-485 or Ethernet devices/architectures to the system components within the respective gaming machine. The GMU (shown as GMU 207 in FIG. 2A) has a connection to the base game through a serial SAS connection. The system components in the gaming cabinet may be connected to the servers using HTTPs or other protocols over Ethernet. Using CMS 807 and/or SMS 805 servers and devices, firmware, media, operating systems, and configurations may be downloaded to the system components of respective gaming devices for upgrading or managing floor content and offerings in accordance with operator selections or automatically depending upon CMS 807 and SMS 805 master programming. The data and programming updates to gaming terminals 803 are authenticated using conventional techniques prior to install on the system components.

In various embodiments, any of the gaming terminals 803 may be a mechanical reel spinning slot machine, video slot machine, video poker machine, video Bingo machine, Keno machine, electronic table game or the like. A gaming system 801 of the type described above also allows a plurality of games in accordance with the various embodiments of the invention to be linked under the control of a group game server (not shown) for cooperative or competitive play in a particular area, carousel, casino or between casinos located in geographically separate areas. For example, one or more examples of group games under control of a group game server are disclosed in Vallejo et al U.S. Published Application 2008/0139305, entitled “Networked System and Method for Group Gaming,” filed on Nov. 9, 2007, which is hereby incorporated by reference in its entirety for all purposes.

The gaming system 801, among other functionalities such as slot accounting (i.e. monitoring the amount wagered (“drop”), awards paid) and other casino services, includes the player tracking CMS/CMP server 837 and/or data warehouse 835 storing player account data. This data includes personal data for players enrolled in the casino players club sometimes referred to as a loyalty club. An example of the personal data is the player's name, address, SSN, birth date, spouse's name and perhaps personal preferences such as types of games, preferences regarding promotions, player rating level, available player comp points (points accumulated based upon commercial “spend” activity with the enterprise including gaming and which may be redeemed or converted into cash or merchandise) and the like. As is known in the industry and according to the prior art, at enrolment the player is assigned a created account in the player tracking CMS/CMP server 837 and is issued a player tracking card having a machine readable magnetic stripe.

[0066]When a player plays a gaming device 10 (or terminal 803) (hereinafter collectively referred to as gaming devices 10), he/she inserts their player tracking card into the card reader 32 (FIG. 1) which communicates data to the CMS/CMP server 837 to accumulate loyalty (“comp”) points based upon the wagers/wins of the player. For example, a player may accumulate one comp point for each $5 wagered. Comp points may also be awarded as part of a promotion and for other commercial activity such as the purchase of goods or services.

The system 801 may also include electronic transfer of funds functionality. For example, a player having accumulated $100 at a gaming terminal 10 may decide to “cash out” to play another gaming terminal 10. The player, for example using the PTM 28 to initiate communication with the system 801 for example server 837 to upload the value from the gaming terminal 10 into an electronic account associated with the player's account. The reading of the player's card by the card reader 32 supports access to the player's account. The player may choose to upload all or a portion of the funds the player's established electronic account. The system would prompt the player to enter their PIN (or obtain biometrical confirmation as to the player's identity) and upload the chosen amount to their account. When the player moves to another gaming device 10 he/she inserts their player loyalty card into the card reader 32 to access their account. A prompt provides for the player to request funds from their account. Entering their PIN (or biometric identifier) the player can input the desired amount which is downloaded to their gaming terminal 10 for play.

### Modular Card Reader

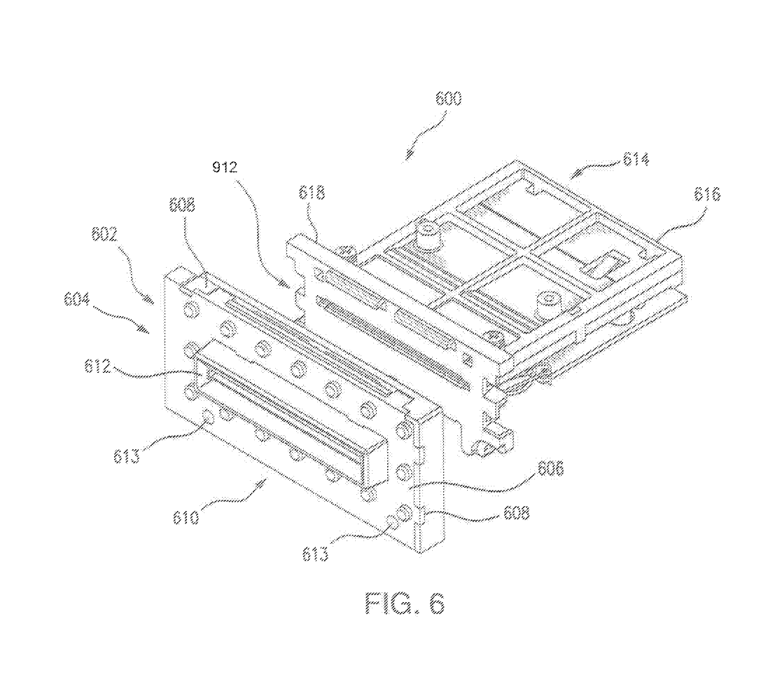

With reference to FIG. 6 an embodiment of a modular card reader 600 is depicted in a partial, exploded view. To secure the modular card reader 600 to a player tracking module bracket 1200 (FIG. 12) the modular card reader 600 includes a rectangular bezel sub-assembly 602. The player tracking bracket 1200 mounts or exposes the components for the PTM 28 when mounted to a gaming device 10. The bezel sub-assembly 602 is adapted at one side to mount an LED array 604 which includes an LED controller and lens array 606. To mount the LED and lens array 604, 606 the bezel sub-assembly 602 has recesses 608 disposed about its periphery to mate with the LED and lens arrays 604, 606 for aligning and removeably mounting of the same. To pass a magnetic stripe player tracking card (shown as 1202 in FIG. 12) for reading thereof a mouth 610 is formed through the bezel assembly 602 to extend through the LED and lens arrays 604, 606 and has a protruding lip 612 about the mouth 610 to guide and support insertion of a player tracking card 1202. Holes 613 through the bezel sub-assembly accommodate fasteners such as screws to secure the bezel sub-assembly to the PTM 28 bracket 1200.

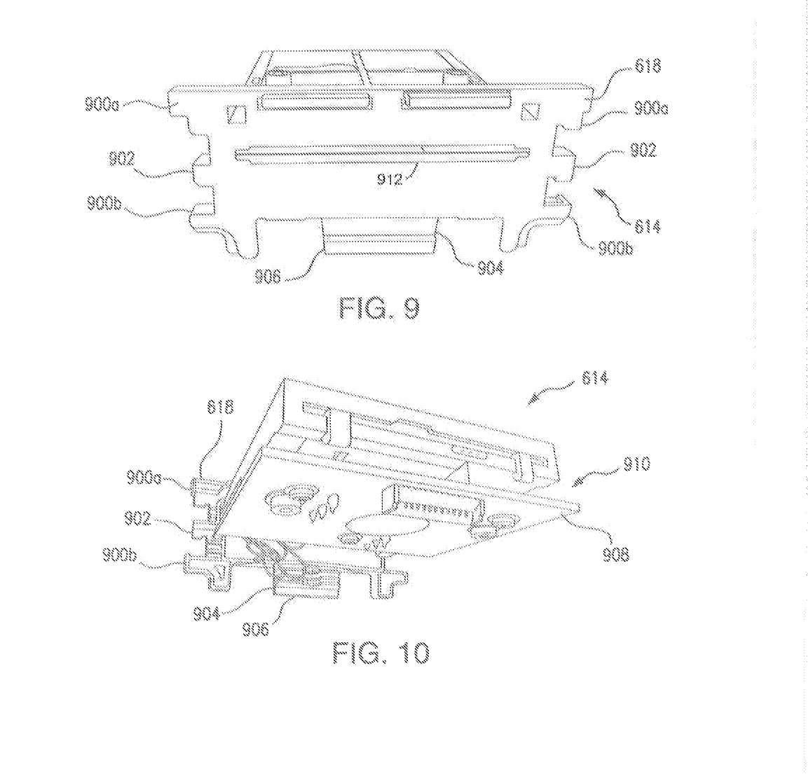

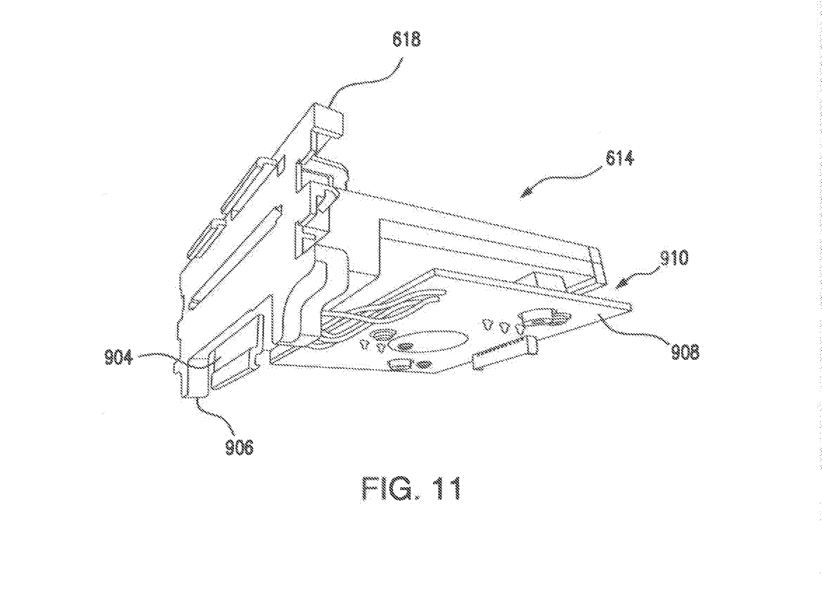

Releasably secured to the back of the bezel sub-assembly 602 in a manner hereinafter described is a card reader controller subassembly 614. The controller sub-assembly 614 has a ridged substrate 616 terminating at one end at a vertical adapter 618. FIGS. 9-11 show various views of the controller sub-assembly 614 and adapter 618. To mate with and couple to the generally rectangular bezel sub-assembly 602 the adapter 618 is likewise generally rectangular including at each side outwardly extending tabs 900a, b on either side of outwardly extending fingers 902. To mate with and couple to the bezel sub-assembly 602 a male-female coupling is provided between the card reader controller subassembly 614 and bezel sub-assembly 602. As shown a male component of the male-female coupling may be embodied as a rectangular leg 904 depending at the bottom of the adapter 618 and having at the extremity thereof a rectangular foot 906. The foot 906 may be C-shaped in cross section.

The substrate 616 mounts to the underside thereof a card reader and controller board 908 which includes a magnetic stripe reader head and the hardware/firmware/software to provide card reading as well as processing the raw “read” data for ultimate passing to data utilization resources. These components are well known. Included with the controller board 908 may be switches which detect insertion of the player tracking card 1202 into the modular card reader 600. A space 910 is defined between the substrate 616 and controller board 908 for receiving the insertion of the player tracking card 1202. A card receiving channel 912 is provided through the adapter 618 which, when the controller sub-assembly 614 is secured to the bezel sub-assembly 602 aligns with the mouth 610 thus enabling the player to insert their player card 1202 into the space 910 of the modular card reader 600 for reading of the card.

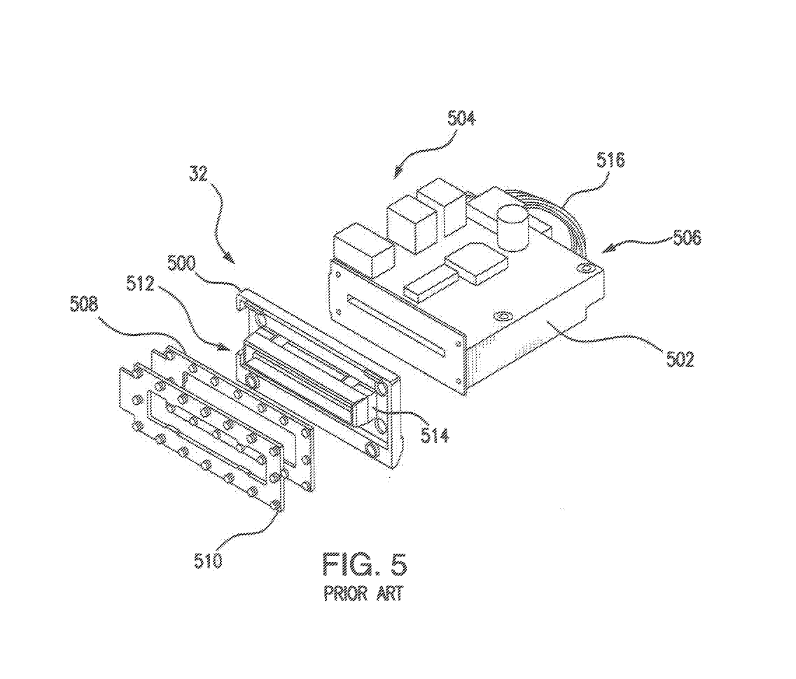

As with prior card readers such as described with reference to FIG. 5, the functionality of the modular card reader 600 includes receiving a player card 1202 for reading, one or more switches to sense insertion of the card, a magnetic stripe reader and processing to process the raw data from the reader head. The controller sub-assembly 614 includes an interface to the controller of the LED array 604 to provide a “read” or “not read” signal to control the LED array 604 to light to indicate of the status of the insertion and card reading, e.g. to light in a color red if the insertion or reading failed and to light in a color green if insertion and reading has occurred The controller board 908 includes electronic harness connections to provide power to the controller board 908, to connect the controller board to LED array 604 and to one or more processors or devices for providing card data to data utilization resources such as the back-end system(s) described above such as the GMU 207.

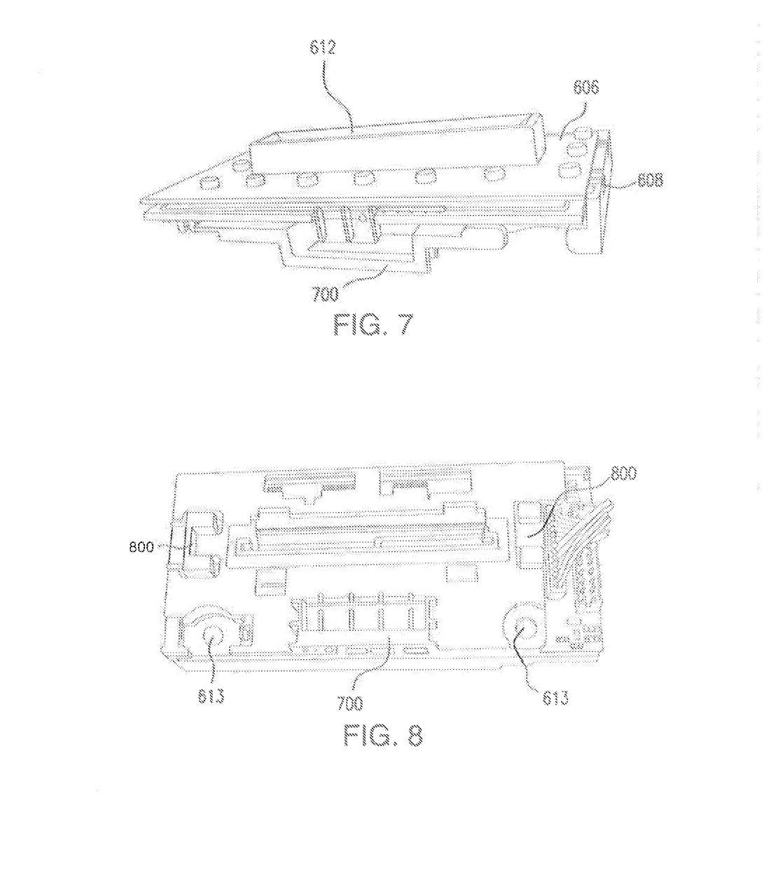

To provide for the releasable assembly of the controller sub-assembly 614 to the bezel sub-assembly 602, the bezel sub-assembly 602 as shown in FIGS. 7 and 8 includes the other of the male-female connecting component such as a female catch 700 located at the bottom margin defined generally as a rectangular loop. It should be understood that the male-female components may be switched between the controller sub-assembly 614 and bezel sub-assembly 602 or other types of releasable mechanical connectors may be provided such as, for example, a twist lock connector, slide lock or the like. The catch 700 is profiled to receive the leg 904 of the adaptor 618 there through when the adaptor 618 is mated to the bezel sub-assembly 602 such that the foot 906 captures the catch 700 loop. To impose a bias to maintain the aforementioned capture, slots 800 (FIG. 8) are provided at the rear of the bezel sub-assembly 602 to receive the fingers 902 of the adaptor 618 in a fashion to impose an upward bias on the adaptor 618 and the capture of the catch 700 loop by the foot 906 to maintain the aligned engagement between the bezel sub-assembly 602 and the controller sub-assembly 614. Once connected the various power/data connections can be made to configure the modular card reader in an active state.

FIG. 12 shows the connection of the bezel sub-assembly 602 to the bracket 1200 and the attachment of the controller sub-assembly 614 to the bezel sub-assembly 602. The bezel sub-assembly 602 is secured to the bracket 1200 by fasteners 1204 such that the lens array 608 aligns to project the lenses through a matching array of holes 1206 in the bracket 1200. The lip 612 projects through an opening 1208 also made through the bracket 1200. An outer clear/translucent cover (not shown) may be mounted at the exterior of the bracket 1200 over the lens array 608.

As discussed above, with prior art card readers when there is a failure the reader is removed and replaced as a unit. An advantage of the modular card reader 600 according to an embodiment of the present invention is that, when a card reader fails the service technician simply uncouples the power/data harnesses and disengages and replaces the controller sub-assembly 614 leaving the bezel assembly 602 in place. The controller sub-assembly 614 is believed to cost in the range of one-third of the entire card reader of the prior art. Still further either one or both of the bezel sub-assembly 602 and controller sub-assembly 614 can be sourced to multiple vendors to obtain the best pricing as long as the units include the interconnecting structure of the bezel sub-assembly 602 and adaptor 618.

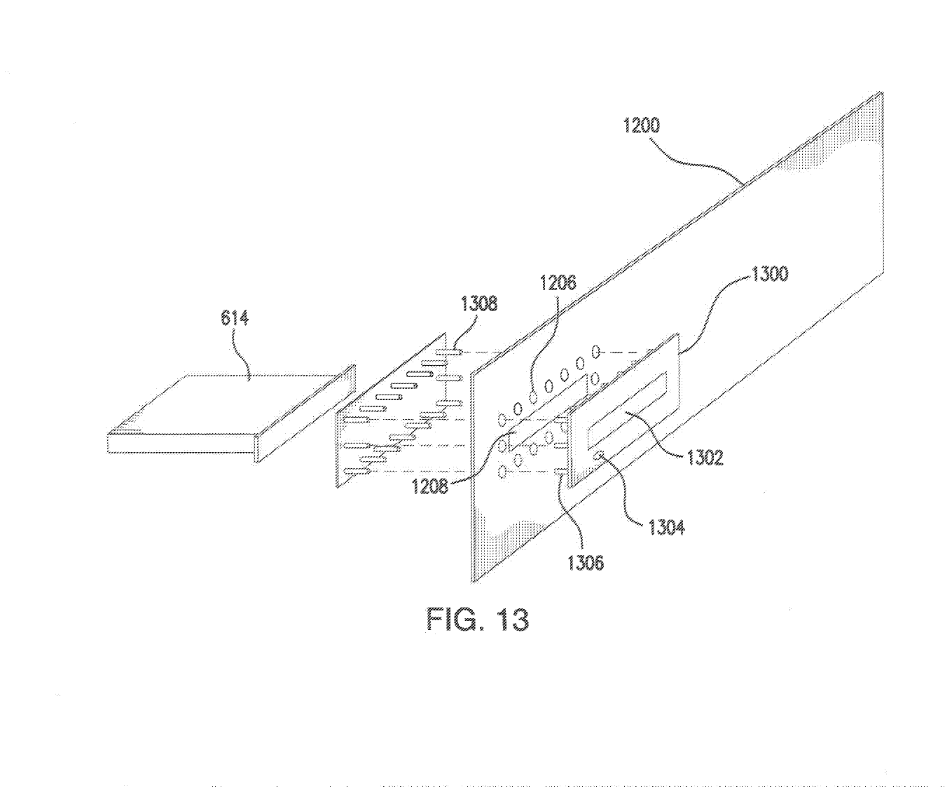

Turning to FIG. 13 an additional embodiment of the present invention is shown to accommodate a wireless receiver/transceiver (WRT) unit 1300 mounted to the exterior of the bracket 1200. The WRT unit 1300 includes a slot 1302 for passing a player loyalty card 1202 for reading in the manner described above and may also mount one or more digital camera(s) 1304. To provide power and data transfer the WRT unit 1300 has one or more pins 1306 configured to extend through the holes 1206 (FIG. 12) established to accommodate the lenses of the lens array 608. The pins 1306 are received by sockets 1308 at a modified and configured bezel sub-assembly 602a. Bezel sub-assembly 602a may be of generally the same construction as described above the LED and lens arrays 606, 608 removed but still including the holes 613 to accommodate the fasteners as well as the loop 700. The controller sub-assembly 614 may be as described above. Electrical and data harnesses (not shown) connect the bezel sub-assembly 602a to one or more of the controller assembly 614 of processors/routers for receiving and processing wireless signals received by the WRT unit 1300 and data representing images captured by the camera(s) 1304 as well as controlling emission of wireless signals and operation of the camera(s) 1304. As but an example, the modular card reader of this embodiment may control the camera(s) 1304 to capture an image of the player upon insertion of a player card into the modular card reader or, for example, where a player engages in funds transfers or the like. Images may also be captured to provide three-dimensional graphics effects such as described in Kelly et al, U.S. Pat. No. 8,721,427 issued May 13, 2014 and titled “Gaming System, method and Device for Generating Images Having a Parallax Effect Using Face Tracking” the disclosure of which is incorporated by reference. The controller assembly 614 is releaseably attached to the bezel assembly 612a in the manner described above. As can be appreciated the modular card reader of FIG. 13 provides for magnetic stripe card reading functionality as well as the ability to provide wireless communication with a player device such as a wireless enabled smart card, key fob or a device such as a smart phone or the like. Further one or more digital cameras 1304 may be provided for capturing biometric samples such as facial images. In a further embodiment a fingerprint scanner may be provided in the place of or in addition to the one or more camera(s) 1304 to capture fingerprint images for the purposes of verifying the identity of the player.

The foregoing description, for purposes of explanation, uses specific nomenclature and formula to provide a thorough understanding of the invention. It should be apparent to those of skill in the art that the specific details are not required in order to practice the invention. The embodiments have been chosen and described to best explain the principles of the invention and its practical application, thereby enabling others of skill in the art to utilize the invention, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

1. A modular card reader to be attached to an enclosure and to derive data from reading of an identification card and provide data to one or more external card reading data utilization resources comprising:
a bezel sub-assembly secured to the enclosure and including (a) a mouth to receive an inserted identification card and (b) one of a leg defining a male component and a capturing loop defining a female component;
first and second controller sub-assemblies each having a substrate mounting a card reader and controller processor board and (b) the other of the male and female component, each controller sub-assembly including a space to align with the mouth to receive an identification card for the reading thereof, engagement of the male and female components of the first controller sub-assembly releasably securing the first controller sub assembly to the bezel sub assembly without removal of the bezel sub assembly from the enclosure and
electrical and data couplings for coupling the controller sub-assembly to the one or more data utilization resources, the card reader controller processor board configured for reading the data and providing the data to external data utilization resources;
whereby disengagement of the male and female components and electrical sub-data couplings frees the first controller sub controller to be disconnected from the bezel sub assembly without removal of the bezel sub-assembly from the enclosure for replacement with the second controller sub-assembly by engagement of the male and female components between the second controller sub assembly and the bezel sub-assembly and electrical and data couplings for the second controller sub-assembly.

2. The modular card reader of claim 1 comprising the bezel sub-assembly includes a projecting loop defining a female component for a releasable mechanical connection and each of the controller sub-assemblies includes an adaptor with the leg defining the male component for a releasable mechanical connection, the leg engaging into the loop to releaseably connect a controller sub-assembly to the bezel sub-assembly.

3. The modular card reader of claim 2 comprising the adaptor includes a finger and the leg includes a foot to capture the loop, the finger configured to engage structure at the bezel sub-assembly to impose a bias to maintain engagement with the loop.

4. The modular card reader of claim 1 comprising a wireless transceiver unit configured to read wirelessly transmitted data from a user wireless enabled portable identification instrument and coupled to the bezel sub-assembly to receive power and for communicating said wirelessly transmitted data to a data utilization resource.

5. The modular card reader of claim 1 comprising a unit including a digital camera coupled to the bezel sub-assembly to receive power and for communicating the data representing images acquired by the camera a data utilization resource,

6. A modular card reader for a device of the type having an enclosure with an interior and an exterior and including an opening for mounting the reader assembly and for adapting a plurality of card reader controller sub-assemblies having different form factors, each form factor including a throat to receive a user identification card for reading data therefrom and a coupling for connection to a power source and for communicating data between said card reader and one or more data utilization resources, the card reader comprising:
a bezel sub-assembly attached to the enclosure opening and including a slot for passing a user's identification card to a card reader throat and one of a male and female component for a releasable mechanical connection; and
an adaptor provided on each card reader and controller sub-assembly, the adaptor having the other of the male and female component to engage for connecting the enclosure attached bezel sub-assembly with any card reader and controller sub-assembly including the adaptor and aligning said throat and slot for receipt of a user's identification card for reading.

7. The modular card reader of claim 6 comprising the bezel sub-assembly includes a loop defining the female component for the releasable mechanical connection and the adaptor has a leg defining the male component for the releasable mechanical connection, the leg engaging in said the loop to releaseably connect any controller sub-assembly to the bezel sub-assembly.

8. The modular card reader of claim 7 comprising the adaptor includes a finger and the leg includes a foot to capture the loop, the finger configured to engage structure at the bezel sub-assembly to impose a bias to maintain said capture of the loop.

9. The modular card reader of claim 6 comprising a wireless transceiver unit configured to read wirelessly transmitted data from a user wireless enabled portable identification instrument and coupled to the bezel sub-assembly to receive power and for communicating wirelessly transmitted data to a data utilization resource.

10. The modular card reader of claim 6 comprising a unit including a digital camera coupled to the bezel sub-assembly to receive power and for communicating the data representing images acquired by the camera a data utilization resource.

11. In a gaming machine card reader of the type having a bezel and a magnetic card reading controller sub-assembly for reading a magnetic stripe card, a method for interchanging or replacing a first card reader controller sub-assembly with a different form factor second controller sub-assembly without removal and replacement of the entire card reader comprising:
providing bezel sub-assembly for attachment to the gaming machine, the bezel sub-assembly having a loop proximate a first margin thereof and slots disposed at other margins;
configuring each of the first and second controller sub-assemblies to include a card reader, data and electrical couplings and an adaptor including (1) a leg configured to engage into the loop and secure the controller sub-assembly to the bezel sub-assembly and (b) fingers to engage into the slots to impose a bias to maintain the engagement; and
providing for the interchange of second controller sub-assembly with first controller sub-assembly by
urging release of the leg from the loop against the bias to free the first controller from the bezel sub-assembly,
disconnecting the data and electrical couplings,
engaging the leg of the adaptor o f the second controller sub-assembly into the loop and the fingers into the slots to secure the second controller sub-assembly to the bezel sub-assembly, and
reconnecting the data and electrical couplings.
